(19) United States
(12) Patent Application Publication
(10) Pub. No.: US 2021/0158451 A1
(43) Pub. Date: May 27, 2021

(54) SYSTEMS AND METHODS FOR DETERMINING INSURANCE COVERAGE RECOMMENDATIONS BASED ON LIKELIHOOD OF USE

(71) Applicant: Lockton, Inc., Kansas City, MO (US)

(72) Inventors: Shane Blazek, Shawnee, KS (US); David Embry, Kansas City, MO (US); Niki French, Leawood, KS (US); Andrea Rosen, Overland Park, KS (US)

(21) Appl. No.: 16/698,663

(22) Filed: Nov. 27, 2019

(51) Int. Cl. G06Q 40/08; G06N 20/00

(52) U.S. Cl. CPC G06Q 40/08; G06N 20/00

(57) ABSTRACT

Systems and methods are disclosed for generating a coverage recommendation. A computer-implemented method may use a computer system that includes one or more physical processors. The computer-implemented method may include: obtaining business information for a business entity, determining business type of the business entity based on the business entity information, obtaining historic incident information for business entities of the business type, determining a likelihood of occurrence of one or more incidents that adversely impact the business entity based upon the business information and the historic incident information, determining a coverage product for mitigating the likelihood of occurrence of each incident, generating a coverage recommendation including an explanation for the coverage product determination, and effectuating presentation of the coverage recommendation to the user via a graphical user interface.

### TECHNICAL FIELD

The present disclosure is generally related to insurance. More particularly, the present disclosure is directed to systems and methods for determining insurance coverage needs of a user based on a likelihood of actually using the coverage.

### BACKGROUND

Insurance selection, regardless of the type of coverage, is usually based on determining what coverage one may need. For example, when selecting a health insurance policy, a person may do so by estimating a likelihood of adverse health events occurring. An overestimation may result in unnecessarily high insurance premiums, while an underestimation may result in lack of coverage to the insurance holder's detriment.

Similarly, when establishing and operating a business, selecting appropriate insurance coverage is a necessity. Different types of business insurance provide different types of coverage. For example, some insurance policies are designed to protect against damages to business's property such as offices, warehouse, vehicles, equipment, and inventory. Others, protect against losses resulting from crimes, such as theft or even employee fraud. Others still, protect the company in the event of a lawsuit (e.g., business liability insurance.)

In some instances, a business entity may be required to purchase certain types of business insurance in order to operate. For example, some states require every business with a certain number employees to have workers compensation, unemployment, and disability insurance. Another example is a requirement to purchase Auto Liability insurance if a business entity owns and/or operates a vehicle.

Because of this multitude of differing types of business insurance policies and requirements, the selection task may be overwhelming, as it requires the business to adequately assess their business needs and risk. For example, recommended coverage levels vary greatly based on each specific business operation in conjunction with the underlying state mandated coverage requirements. Often, conventional insurance companies look to the customer to provide them their needs when selecting an insurance product or policy. However, because most businesses cannot adequately assess their insurance needs, the insurance products and the coverage selected by the customer results in the business being either under- or over-insured. That is, if a company is underinsured, it risks exposing itself to a potential financial loss. Similarly, if the company purchases coverage for events that are either not relevant to their business or have a low incidence of occurrence, the business incurs unnecessary expenses. Accordingly, businesses cannot readily and accurately determine what products and/or coverage levels would be appropriate for their specific business circumstances.

### SUMMARY

In accordance with one or more embodiments, various features and functionality can be provided to enable or otherwise facilitate determining insurance product and coverage needs based on likelihood of user requiring the coverage.

Embodiments of the disclosure are directed to systems and methods for generating a coverage recommendation. In one embodiment, the method may include obtaining business information for a business entity. The method may also include determining business type of the business entity based on the business entity information. The method may further include obtaining historic incident information for business entities of the business type. The historic incident information may include historic incidents that adversely affected the business entities. The method may also include determining a likelihood of occurrence of one or more incidents that adversely impact the business entity based upon the business information and the historic incident information. The method may further include determining a coverage product for mitigating the likelihood of occurrence of each incident. The method may also include effectuating presentation of the coverage recommendation to the user via a graphical user interface.

In some embodiments, the business information may include information related to the business entity including at least one of a services performed by the business entity, employees employed by the business entity, real property occupied by the business entity during performance of the services, a geographic location of the real property, one or more geographic locations in which the business services are performed by the business entity, assets owned by the business entity, vehicles used by the business entity during the performance of the services, and revenue. The business information is provided by the user via the graphical user interface.

In some embodiments, the method may further include obtaining one or more satellite images of the geographic locations associated with the real property occupied by the business entity.

In some embodiments, the determining the likelihood of occurrence of the one or more incidents may be based on the satellite images of the geographic locations associated with the real property occupied by the business entity.

In some embodiments, the method may further include obtaining historic crime information related the geographic location of the real property occupied by the business entity during performance of the services and the one or more geographic locations in which the business services may be performed by the business entity.

In some embodiments, the method may further include determining a coverage carrier providing the coverage product based on the coverage product determination.

In some embodiments, the method may further include obtaining regulatory requirements based on the information of employees employed by the business entity.

In some embodiments, the determining the coverage product may utilize the regulatory requirement.

In some embodiments, the method may further include receiving a selection from a user comprising the coverage product.

In some embodiments, the determining the likelihood of occurrence of the one or more incidents that adversely impact the business entity may be calculated using Bayesian statistics.

In another embodiment, the method may be implemented by a computing system including one or more physical processors and storage media storing machine-readable instructions. The

In another embodiment, a system for generating a coverage recommendation is disclosed. The system may include one or more physical processors configured by machine-readable instructions to perform a number of operations. One operation may include obtaining business information for a business entity. Another operation may include determining business type of the business entity based on the business entity information. Another operation may include obtaining historic incident information for business entities of the business type. The historic incident information may include historic incidents that adversely affected the business entities. Yet another operation may include determining a likelihood of occurrence of one or more incidents that adversely impact the business entity based upon the business information and the historic incident information. Another operation may include determining a coverage product for mitigating the likelihood of occurrence of each incident. Another operation may include generating a coverage recommendation including an explanation for the coverage product determination. Yet another operation may include effectuating presentation of the coverage recommendation to the user via a graphical user interface. In some embodiments, the determining the likelihood of occurrence of the one or more incidents that adversely impact the business entity may be calculated using at least one of a machine learning algorithms, neural networks, and deep learning algorithms.

### BRIEF DESCRIPTION OF THE DRAWINGS

FIG. 1 an example system configured to generate insurance coverage recommendations, according to an implementation of the disclosure.

FIG. 2 illustrates an example coverage recommendation server of the example system illustrated in FIG. 1, according to an implementation of the disclosure.

FIG. 3 illustrates an example predictive method for determining a likelihood of an insurable incident occurrence determined by the system of FIG. 1, according to an implementation of the disclosure.

FIG. 4 illustrates an example process for generating insurance coverage recommendations based on the determination of the insurable incident of FIG. 3, according to an implementation of the disclosure.

FIG. 5 illustrates an example computing system that may be used in implementing various features of embodiments of the disclosed technology.

### DETAILED DESCRIPTION

Described herein are systems and methods for determining insurance coverage needs based on likelihood of business requiring the coverage. The details of some example embodiments of the systems and methods of the present disclosure are set forth in the description below. Other features, objects, and advantages of the disclosure will be apparent to one of skill in the art upon examination of the following description, drawings, examples, and claims. It is intended that all such additional systems, methods, features, and advantages be included within this description, be within the scope of the present disclosure, and be protected by the accompanying claims.

As alluded to above, over-insurance could put a financial burden on a business, but buying inadequate insurance coverage could be even more dangerous. Getting adequate insurance coverage that meets specific business needs rather than what the business may think it needs minimizes potential risks and financial burden.

Conventional insurance coverage recommendations are usually generated based on a limited set of information about a business including information that the business thinks they need. Often, these recommendations are generated by a licensed insurance agent who relies on past industry experience, recommendations from insurance carriers, and general insurance industry guidelines. However, conventional insurance recommendations generated this way often result in providing the business with coverage that does not address the issue of balancing potential risks and insurance costs.

In accordance with various embodiments, a business owner can obtain insurance coverage recommendations fit for their particular business needs. That is, instead of receiving insurance product and coverage recommendation based on what the business owner thinks their business may require or what the licensed agent may think they require, as alluded to above, the user can receive recommendations that they actually need. For example, the system may determine a business classification based on information provided by the business owner. The information provided by the business owner may be related to their business and operations including, for example, the industry of their operation, property owned by the business, number of employees, and/or other relevant data. Using the business information provided by the owner, the system may determine the business or industry classification. Further, based on the business classification, the system may obtain relevant historic claim data and determine insurable events and a likelihood of individual insurable incident(s) occurrence for businesses in the same classification. Next, the system may determine a level of coverage for the business based on the corresponding likelihood of insurable incident occurrence determination. For example, upon determining that the likelihood of a particular insurable incident is high, the level of recommended coverage may also be high. Similarly, if the likelihood of an insurable incident is low, the level of recommended coverage may be low.

In some embodiments, in addition to determining the corresponding likelihood of insurable incident occurrence, the system may also determine a cost associated with that incident (i.e., cost of repairing the damage caused by the incident). For example, a system may determine that an insurable incident with a low likelihood of occurrence may have a high associated cost. Thus, the system may determine the level of coverage based on both the corresponding likelihood of insurable incident occurrence determination and the associated cost. For example, in a low likelihood and high cost determination, the level of recommended insurance coverage may be high. By virtue of utilizing the associated cost, results in a more accurate determination of the recommended coverage.

Finally, the system may use the insurance coverage determinations to generate insurance policy recommendation that fit particular business needs. For example, if the determined level of coverage against a particular insurable incident is low, the system may recommend purchasing only minimal insurance coverage. Because premiums associated with lower coverage tend to also be lower, determining insurance coverage based on a likelihood of insurable incident occurrence allows the system to generate recommendations only for the coverage the business will likely need as determined in accordance with the embodiments described herein. That is, the business owner obtains an insurance coverage recommendation that reduces their liability without unnecessarily increasing financial burden associated with being over-insured.

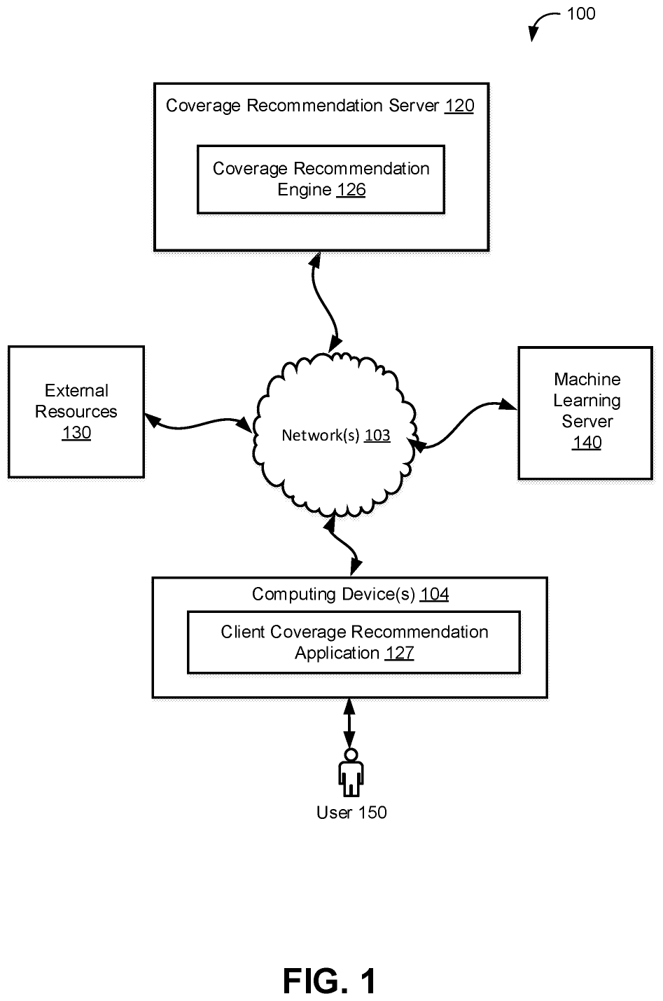

Before describing the technology in detail, it is useful to describe an example system in which the presently disclosed technology can be implemented. FIG. 1 illustrates one such example insurance recommendation system 100.

FIG. 1 illustrates an example insurance recommendation system 100 which permits business owners to obtain insurance recommendations that are tailored to their unique business needs and circumstances. As alluded to above, the insurance recommendation may be generated by determining a likelihood of insurable events occurring for a business entity. In some embodiments, system 100 may include a coverage recommendation server 120, a machine learning server 140, external resources 130, a one or more client computing devices 104, and a network 103. A user 150 may be associated with client computing device 104 as described in detail below.

In some embodiments, coverage recommendation server 120 may include a processor, a memory, and network communication capabilities. In some embodiments, coverage recommendation server 120 may be a hardware server. In some implementation, coverage recommendation server 120 may be provided in a virtualized environment, e.g., coverage recommendation server 120 may be a virtual machine that is executed on a hardware server that may include one or more other virtual machines. Coverage recommendation server 120 may be communicatively coupled to network 103. In some embodiments, coverage recommendation server 120 may transmit and receive information to and from one or more of client computing devices 104, machine learning server 140, external resources 130, and/or other servers via network 103.

In some embodiments, as alluded to above, coverage recommendation server 120 may include a distributed coverage recommendation engine 126 and a corresponding client coverage recommendation application 127 running on one or more client computing devices 104.

In some embodiments, users of coverage recommendation system 100 (e.g., business owners) may access the coverage recommendation engine 126 via client computing device(s) 104. In some embodiments, the various below-described components of FIG. 1 may be used to initiate coverage recommendation application 127 within client computing device 104. In some embodiments, coverage recommendation application 127 may be configured to obtain information related to the business entity entered by user 150 and display coverage recommendations determined by coverage recommendation engine 126. For example, coverage recommendation application 127 may be configured to allow users to enter business name, business type, business activities, and/or other similar information. In some embodiments, business owners may be required to provide various information related to their business and operations via one or more follow-up questions based on the information provided, as described in further detail below.

In some embodiments, machine learning server 140 and/or other components of lead distribution system 100 may be configured to use machine learning, e.g., use a machine learning model that utilizes machine learning to determine business classification and a corresponding insurance carrier classification. In some embodiments, machine learning may be used to determine a likelihood of an insurable incident occurrence based on the business information and business classification, as described in further detail below. In some embodiments, machine learning server 140 may include one or more processors and memory and network communication capabilities. In some embodiments, machine learning server 140 may be a hardware server connected to network 103, using wired connections, such as Ethernet, coaxial cable, fiber-optic cable, etc., or wireless connections, such as Wi-Fi, Bluetooth, or other wireless technology. In some embodiments, machine learning server 140 may transmit data between one or more of leads processing server 130, client computing device 104, external resources 130, and/or other components via network 103.

In some embodiments, external resources 130 may comprise one or more of carrier platforms provided by one or more external insurance agencies or systems. In some embodiments, external resources 130 may comprise one or more underwriting platforms used by one or more insurance agencies or systems. In some embodiments, submission platforms may include one or more servers, processors, and/or databases that can store business classification information, insurance product information, historic claim information, and other such information provided by one or more external systems resources 150. For example, insurance product information may be used by coverage recommendation engine 126 when determining insurance recommendations, as will be further described in detail below.

In some embodiments, coverage recommendation engine 126 may communicate and interface with a framework implemented by external resources 130 using an application program interface (API) that provides a set of predefined protocols and other tools to enable the communication. For example, the API can be used to communicate particular data from an insurance carrier used to connect to and synchronize with coverage recommendation engine 126.

In some embodiments, client computing device 104 may include a variety of electronic computing devices, such as, for example, a smartphone, tablet, laptop, computer, wearable device, television, virtual reality device, augmented reality device, displays, connected home device, Internet of Things (IOT) device, an enhanced general packet radio service (EGPRS) mobile phone, a media player, a navigation device, a game console, a television, a remote control, or a combination of any two or more of these data processing devices, and/or other devices. In some embodiments, client computing device 104 may present content to a user and receive user input. In some embodiments, client computing device 104 may parse, classify, and otherwise process user input. For example, client computing device 104 may store user input associated with an agent claiming or selecting a lead, as will be described in detail below.

In some embodiments, client computing device 104 may be equipped with GPS location tracking and may transmit geolocation information via a wireless link and network 103. In some embodiments, coverage recommendation server 120 and/or distributed chat application 126 may use the geolocation information to determine a geographic location associated with user 150. In some embodiments, coverage recommendation server 120 may use signal transmitted by client computing device 104 to determine the geolocation of user 150 based on one or more of signal strength, GPS, cell tower triangulation, Wi-Fi location, or other input. In some embodiments, the geolocation associated with user 150 may be used by one or more computer program components associated with coverage recommendation engine 126 during coverage recommendation determination.

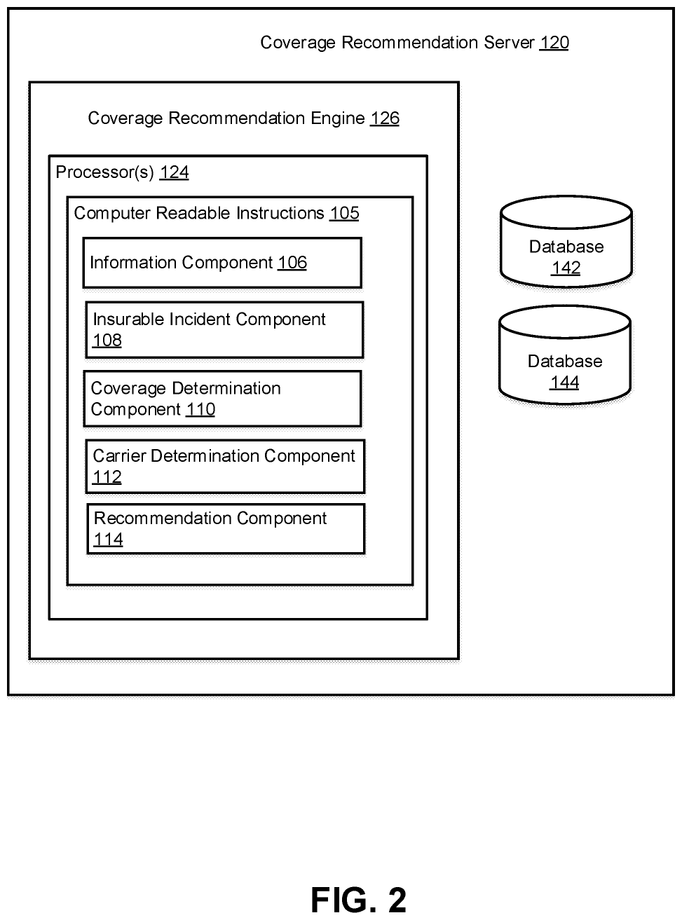

FIG. 2 illustrates an example coverage recommendation server 120 of insurance recommendation system 100 illustrated in FIG. 1 configured in accordance with one embodiment. In some embodiments, the various below-described components of FIG. 2 may be used to determine insurance coverage recommendations based on specific business circumstances, as described herein.

In some embodiments, coverage recommendation server 120 may include coverage recommendation engine 126, as alluded to above. In some embodiments, coverage recommendation engine 126 may be operable by one or more processor(s) 124 configured to execute one or more computer readable instructions 105 of one or more computer program components. In some embodiments, the computer program components may include one or more of a business information component 106, an insurable incident component 108, a coverage determination component 110, a carrier determination component 112, a recommendation component 114, and/or other such components.

In some embodiments, coverage recommendation server 120 may also include one or more databases. For example, databases 142 and 144 may be used to store data used by coverage recommendation engine 126. For example, database 142 may store business owner information received via client computing device 104. In some embodiments, database 144 may store insurance coverage and historical claim information associated with other users of coverage recommendation system 100. For example, claim information may include business entity type, class of business, policy type, coverage type, loss type, loss date, length of claim (from report to close), carrier, state, estimated reserve at time of reporting, final payout by line of coverage, paid or denied status.

In other embodiments, database 144 may store insurance coverage and historical claim information associated with users of third party partners associated with coverage recommendation system 100. For example, the third party partner utilizing system 100 may provide information related to insurance coverage of their clients.

In some embodiments, business information component 106 may be configured to obtain information related to a business entity for which insurance coverage is being sought. For example, business information component 106 may be configured to obtain information that is being provided by user input via client computing device 104.

In some embodiments, business information may include information characterizing the activity of the business. For example, business information may include business type or industry type and sub-type, services provided, customers being serviced, and so on.

In some embodiments, the likelihood of insurable events occurring for a business may be based on a particular type of the business. For example, business entities of particular types and/or those operating in particular geographical areas may be associated with particular industry rankings or hazard grades with known likelihoods of insurable event occurrences. By virtue of determining a business type (e.g., classifying business activities) results in a more accurate insurance recommendation. In some embodiments, business type may be determined by using user specified information related to activity of the business, as described herein.

In some embodiments, business information specified by the user may be used by coverage recommendation engine 126 to determine a business type or an industry classification of the business. In some embodiments, by determining industrial classification of the business, coverage recommendation engine 126 may determine an appropriate insurance liability class which may be used by the insurers to quantify the risk they assume when underwriting liability insurance policies. For example, the insurance liability class may include an numeric or an alphanumeric code and may be used as input by insurers when calculating insurance premiums.

Many insurers base their liability class codes on data collected by the Insurance Services Office (ISO). Alternatively, some insurers consider other organization's data, such as that provided by the North American Industry Classification System (NAICS), the Standard Industrial Classifications (SIC) or the National Council on Compensation Insurance (NCCI). Additionally, insurers are free to use their own information that they collect themselves. Notably, insurers do not all use the standardized liability class codes. Thus, insurers' lists of codes vary. Accordingly, by making an accurate business industry classification determination and a corresponding class for multiple insurers is critical for obtaining accurate insurance product recommendations. In contrast, a misclassification of the business may result in improper insurance recommendation and lead to insufficient coverage. For example, a misclassification of a tattoo artist as an artist that engages in retailing art works rather than a business that provides Personal Care Services, would result in the tattoo artist not receiving a recommendation for professional liability insurance that provides protection in the event a tattoo artist makes a mistake while inking a customer. Furthermore, this misclassification of the tattoo artist may result in unpaid insurance claims, the burden for which may be shifted to the insurance broker for this improper categorization.

Conventionally, when determining an industry classification, insurance sellers often provide users with several drop down menus that may include general industry categories and sub-categories. For example, a user operating a beauty salon may select Personal Care Services category and Hair, Nail, and Skin Care Services sub-category. However, because the drop down menus may include limited or incomplete information, classification may be inaccurate. Furthermore, classification may be complicated to a novice or inexperienced business owner who may not familiar with which industry category or subcategory to select. For example, a user operating a tattoo parlor may mistakenly select Art Studio industry rather than Personal Care Services. Because the risks involved in operating a tattoo parlor are not the same as operating an art studio, using conventional drop down menus when selecting an industry classification may not result in an accurate classification.

In contrast, the present embodiments allow users to enter a brief description using natural language description including activities their business performs. For example, a user may enter a statement “I mow grass” or “I lay shingles.” In some embodiments, business information component 106 may analyze the natural language input and determine that the user performs landscaping services or roofing services, respectively. In some embodiments, business information component 106 may determine that the business performs multiple activities resulting in multiple classifications, as further described in detail below. By virtue of determining accurate industry category, the present embodiments ensure accurate classification of the business and thus result in more accurate coverage recommendation. For example, a more accurate classification may result in a more accurate determination of a likelihood of incident occurrence which in turn will lead to a more accurate coverage determination. Additionally, a more accurate classification may result in more accurate determinations of premiums by the insurers.

In some embodiments, business information component 106, may be configured to determine an industry, an industry group, a subsector, and a sector based on business information provided by the user. For example, upon receiving user input indicating their business activity includes grass mowing, business information component 106 may determine their industry as “Landscaping Services”, industry group as “Services to Buildings and Dwellings”, subsector as “Administrative and Support Services”, and sector as “Administrative and Support and Waste Management and Remediation Services.” In some embodiments, business information component 106 may determine multiple industries, industry groups, subsectors, and sectors based on business information comprising distinct groups of business activities performed by the user, as alluded to above.

In some embodiments, business information component 106 may be configured to determine a corresponding industry, industry group, subsector, and sector associated with one or more insurers based on the business classification (i.e., industry, an industry group, a subsector, and a sector) determined using the business information provided by the user. As alluded to above, accurate classification by the insurer may result in a more precise premium calculation.

In some embodiments, business information may include information related to business specifications. For example, information related to the types of clients the business services, information related to supplier and vendors, transactions and transaction types performed by the business, business revenue information, including monthly, quarterly, and annual revenue information, business property information, employee information, geographic location(s) in which the business entity operates information, and other such information.

In some embodiments, business information component 106 may be configured to prompt the user with questions which are configured to elicit additional information related to users' business operations. For example, information may include questions clarifying whether the services are being performed at customer location only, whether additional activities, not typically associated with the business information (e.g., whether a beauty salon serves alcohol to its customers) and so on. In some embodiments, business information component 106 may be configured to generate additional questions based on previously entered information by the user.

In some embodiments, business information component 106 may be configured to determine one or more preferences associated with a user of a business entity for which coverage recommendation engine 126 is determining coverage recommendations. For example, user's preferences may include price consideration, convenience considerations, time considerations, best value considerations, and other similar considerations. In some embodiments, business information component 106 may be configured to obtain online behavior information associated with the user submitting the coverage recommendation request. In some embodiments, user online behavior may be used to determine user insurance needs. For example, a customer who relies on the online chat feature may value personal service over price. For those customers, system 100 may recommend insurance coverage by a carrier that provides a higher level of customer service at a higher price. In some embodiments, For example, a customer who spent a longer time period on a website or platform is more likely to need immediate insurance coverage than a customer who spent only minimal time and/or was not very active on the website (e.g., activity may be expressed as a number of hits or number of submissions). In some embodiments, a customer's preferred way of being contacted may be indicative of their needs. For example, a customer who wished to be contacted by phone is likely very interested in insurance coverage than a customer who did not provide a contact number.

In some embodiments, business information component 106, may be configured to use machine learning, i.e., a machine learning model that utilizes machine learning to determine business classification based on user input. For example, in a training stage business information component 106 (or other component) may be trained using training data (e.g., business activity and business classification training data) or actual business activity and business classification data in a classification determination context, and then at an inference stage can determine classification. For example, the machine learning model can be trained using synthetic data, e.g., data that is automatically generated by a computer, with no use of user information.

In some embodiments, business information component 106, may be configured to use machine learning to determine one or more user preferences, e.g., preferences for coverage, cost, convenience, best value.

In some embodiments, business information component 106 may be configured to use one or more of a deep learning model, a logistic regression model, a Long Short Term Memory (LSTM) network, supervised or unsupervised model, etc. In some embodiments, business information component 106 may utilize a trained machine learning classification model. For example, the machine learning may include, decision trees and forests, hidden Markov models, statistical models, cache language model, and/or other models. In some embodiments, the machine learning may be unsupervised, semi-supervised, and/or incorporate deep learning techniques.

In some embodiments, insurable incident component 108 may be configured to determine one or more insurable incidents associated with the user and a likelihood of each insurable incident occurrence based on the business information provided by the user to business information component 106. An insurable incident may include an incident that takes place during a particular time period and causes a potential loss for the business. For example, an insurable incident may be an event resulting in property and equipment damage, a customer injury, a breached vendor agreements, an employee injury, lawsuit, loss of business income, loss of reputation, negligence, and so on. For example, based on the business information indicating that employees working at a beauty salon have less than two years of experience, insurable incident component 108 may determine insurable event including injuring a customer with scissors during a haircut for a beauty salon.

In some embodiments, insurable incident component 108 may be configured to determine a likelihood of each insurable incident occurrence based on the business information provided by the user to business information component 106. For example, upon determining a insurable event that includes injuring a customer with scissors during a haircut, as alluded to above, insurable incident component 108 may determine a likelihood of 60 percent of an injury to a customer.

In some embodiments, when determining a likelihood of each insurable incident occurrence, insurable incident component 108 may utilize business information including, business type or industry type, types of services provided, use of vehicle, servicing clients at their locations, use of suppliers, business revenue information, number of employees, licensing requirement, number of employees, level of experience and/or education of employees, geographic location(s) in which the business operates, and other such information. In yet other embodiments, insurable incident component 108 may utilize additional relevant data that may be obtained or determined based the business information. For example, insurable incident component 108 may obtain or determine relevant financial data related to other business of the industry type or sub-type including revenue and growth projections; regulatory requirements including new regulations that may come in effect in the near future; information related to assets owned or operated by the business, such as buildings and vehicles, including engineering data, material data and other similar information, motor vehicle record data, and loss history; crime data including modeling and analysis data; wind/hail loss data, including modeling and analysis data; flood map analysis data, earthquake zone analysis data, probable maximum loss analysis data; existing or future contractual obligation analysis data; satellite imagery analysis data, social network analysis data, public protection classification data, including responsiveness of fire department and water availability, loss cost analysis, and so on. In some embodiments, insurable incident component 108 may utilize both publicly and non-publicly available information.

In some embodiments, insurable incident component 108 may be configured to use historic data related to other clients' businesses when making the insurable incident and the likelihood of each insurable incident occurrence determinations. For example, insurable incident component 108 may obtain historic claim data stored in a database (e.g., client database 144) related to businesses in the same industry. In some embodiments, insurable incident component 108 may be configured to use historic data related to users of third party partners associated with coverage recommendation system 100, as alluded to above. For example, data from third-party partners (e.g., customers of system 100) related to historic claim data of their clients' businesses may be used when making the insurable incident and the likelihood of each insurable incident occurrence determinations.

In some embodiments, insurable incident component 108 may be configured to rank industries within an industry group of the user's business based on an order of relatedness. For example, if no historic information exists in an industry category of the business of user 150, insurable incident component 108 may determine comparable industries within the industry group using a relatedness score assigned. In some embodiments, if no data within any of the industries within the same industry group is found, insurable incident component 108 may be configured to rank industries in other industry groups under the same subgroup, and so on. For example, if no data is found in the Hair Salon industry, insurable incident component 108 may use data in the Barber or Nail Salon industry within the Personal Care Services industry group. Similarly, if no data is found in the Hair Salon industry, insurable incident component 108 may use data found in a Personal Trainer industry within Professional Services subgroup. By virtue of using the relatedness score results in an accurate determination of future insurable incident occurrence despite lack of actual historic data within the same industry.

In some embodiments, insurable incident component 108 may be configured to determine the insurable incident and the likelihood of each insurable incident occurrence using a number of models or methods. For example, Bayesian-type statistical analysis may be used during the likelihood determination.

In some embodiments, insurable incident component 108 may be configured to assign specificity, relevance, confidence, and/or weight to each business attribute used in determining insurable incidents and the likelihood of these incidents occurring. For example, business type or industry type, services provide type, use of vehicle, servicing clients at their locations, use of suppliers, business revenue information, number of employees, licensing requirement, number of employees, level of experience and/or education associated with employees, geographic location(s) in which the business operates, and/or other information may be assigned with specificity, relevance, confidence, and/or weight based on the relevance and relationship between each data point to one another. For example, a higher weight may be assigned to business industry, but a lower weight may be assigned level of employee education. By virtue of assigning different weights to individual business attributes, allows insurable incident component 108 to determine the likelihood more accurately.

In some embodiments, a likelihood of each insurable incident occurrence may be expressed as an incident score. For example, an incident score may be expressed on a sliding scale of percentage values (e.g. 10 percent, 15 percent, . . . n, where a percentage may reflect likelihood of conversion occurrence), numerical values (e.g., 1, 2, . . . n, where a number may be assigned as low and/or high), verbal levels (e.g., very low, low, medium, high, very high, and/or other verbal levels), and/or any other scheme to represent a confidence score. For example, insurable incident component 108 may determine that injuring a customer with scissors has a 60 percent likelihood of occurring, whereas a customer slipping on upswept hair has a 30 percent likelihood of occurring.

In some embodiments, insurable incident component 108, may be configured to utilize machine learning to determine the insurable incident and the likelihood of each insurable incident occurrence based on user input. For example, in a training stage business insurable incident component 108 (or other component) may be trained using training data (e.g., business activity, business classification training data, and historical claim data) or actual business activity and business classification data in an insurable incident determination context, and then at an inference stage can determine insurable incident and the likelihood of each insurable incident occurrence. For example, the machine learning model can be trained using synthetic data, e.g., data that is automatically generated by a computer, with no use of user information.

In some embodiments, insurable incident component 108 may be configured to use one or more of a deep learning model, a logistic regression model, a Long Short Term Memory (LSTM) network, supervised or unsupervised model, etc. In some embodiments, insurable incident component 108 may utilize a trained machine learning classification model. For example, the machine learning may include, decision trees and forests, hidden Markov models, statistical models, cache language model, and/or other models. In some embodiments, the machine learning may be unsupervised, semi-supervised, and/or incorporate deep learning techniques.

In some embodiments, coverage component 110 may be configured to determine one or more insurance products relevant to the user's needs based on business classification determined by business information component 106 and insurable incident and likelihood of insurable incident occurrence determination made by insurable incident component 108. In some embodiments, coverage determinations may include one or more insurance products designed by insurance carriers to protect against particular risk. In some embodiments, insurance products may include products for protecting business interests. For example, products may include Property Insurance, Business Income Coverage, Business Owner's Policy, Comprehensive General Liability, Bodily Injury Liability, Property Damage, Liability, Operations Exposures, Advertisers Personal, Fire Legal Liability, Medical Payments, Commercial Auto, Data Breach, Umbrella Insurance, Fidelity and Surety Bonds and Workers Compensation among others. In other embodiments, insurance products may include products for protecting personal health or life interests of users.

In some embodiments, coverage component 110 may be configured to determine coverage limits or levels associated with each product that are the relevant to user's needs. For example, coverage limits may include a maximum amount of loss associated with a claim made for individual product.

In some embodiments, coverage component 110 may be configured to determine product and coverage limits based on one or more rules. For example, coverage component 110 may use federal, state, and local rules to determine workers compensation coverage requirements. That is, if the user's business operates in Missouri and employs 4 people, coverage component 110 may determine that workers compensation insurance is not required for that user by applying state rules.

In some embodiments, one or more rules and conditions may apply when determining product and coverage limits. In some embodiments, the same product may be recommended in distinct circumstances. For example, cyber insurance product may be determined to be relevant if business information indicates that the business processes and stores credit card payment information. Additionally, cyber insurance product may be determined to be relevant if business information indicates that the business stores personally identifiable information.

In some embodiments, when determining one or more relevant products and coverage limits, coverage component 110 may utilize the one or more personal preferences determined by business information component 106, as alluded to above. For example, upon determining that customer is cost conscious, regardless of coverage (e.g., sometimes customers are getting insurance not because they want the coverage but because they are entering a contract or partnership that requires it), coverage component 110 may select carrier A, who offers less coverage than carrier B, but is less expensive that carrier B.

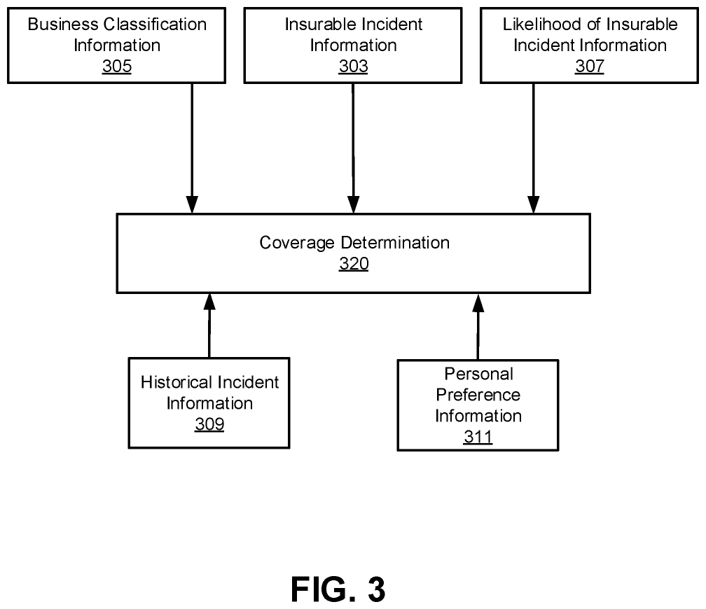

In some embodiments, coverage component 110 may be configured to determine one or more relevant products and coverage limits, using a number of models or methods. For example, Bayesian-type statistical analysis may be used during the likelihood determination. For example, as illustrated in FIG. 3, coverage component 110 may perform a coverage determination analysis 320 which may include a Bayesian-type statistical analysis using business classification information 303, insurable incident information 305, a likelihood of insurable incident determination 307, historical incident information 309, and personal preference information 311.

In some embodiments, coverage component 110, may be configured to use machine learning to determine one or more relevant products and coverage limits

In some embodiments, carrier component 112 may be configured to determine a particular product associated with a particular carrier based on particular product determinations by coverage component 110. For example, a particular carrier may offer multiple policies, each policy including a number of products. By virtue of determining the product first, carrier component 112 may select a policy that fits particular circumstances (i.e., based on coverage needs determined by coverage component 110, which are in turn based on business classification determined by business information component 106 and insurable incident and likelihood of insurable incident occurrence determination made by insurable incident component 108, as alluded to above).

For example, one policy by an insurer may include coverage of Hired and Non Owned Auto, while another policy may not include that coverage. As alluded to above, the business classification determination may be used to determine that the user does not use vehicles in their line of work. Similarly, insurable incident and likelihood of insurable incident occurrence may indicate zero incidents involving vehicles and a zero percent likelihood of an incident involving a vehicle. Accordingly, coverage component 110 may determine that an insurer policy which does not include Hired and Non Owned Auto is more suitable for the user. Conventional insurance determination engines may present both options and leave it up to the customer to select one of them, often resulting in the customer selecting the policy they don't need (i.e., one that has Hired and Non Owned Auto coverage) or resulting in the customer not selecting the policy they do need (i.e., one that does not cover business personal property off premises or in transit). By virtue of determining a particular policy based on business classification and insurable incident and likelihood of insurable incident occurrence determinations, carrier component 112 generates the product determinations that are most applicable to the user.

In some embodiments, carrier component 112 may be configured to determine multiple products associated with one or more carriers. For example, carrier component 112 may be configured to assign a preference to a particular product determination by indicating that this product(s) is preferred or recommended. In yet other embodiments, carrier component 112 may be configured to provide a recommendation explanation detailing reasons why one product is preferred over another, as described in further detail below.

Alternatively, carrier component 112 may be configured to generate products and accompanying recommendation explanations that are not the most applicable to the business. By virtue of generating less applicable products, the user is presented with an overview of all available products rather than only the products system 100 determines the business needs. For example, carrier component 112 may include Hired and Non Owned Auto product and indicate that it is not recommended because the user indicated the business employees do not drive their own vehicles to perform their job. Similarly, carrier component 112 may include Workers Compensation product and indicate that it is not recommended because the user indicated the business employs only three employees, which does not meet the state requirement for Workers Compensation, and because excluding Worker Compensation product lowers the overall cost which is a consideration for the user.

In some embodiments, carrier component 112 may be configured to determine a particular carrier associated with a particular coverage recommendation for a particular product. For example, different carriers may have different coverage limits. By virtue of determining the product recommendation first, carrier component 112 may select policy limits that are applicable to the user. For example, coverage component 110 may determine that the business includes using tools valued at $4,000 at locations outside of the business premises. Based on this determination, carrier component 112 may determine that the policy limit must cover up to $4,000 of property damage, when property is used outside the business premises. For example, carrier A and carrier B may both offer Business Personal Property policies that provide coverage up to $5000-$10,000 to cover property when it is used at the business premises. However, carrier A may only offer up to $2,500 for property damage when the property is used “off premises”. Alternatively, carrier B may offer up to $4,500 when property is “off premises”. Accordingly, carrier B is more applicable to the user's circumstances (i.e., using tools valued at $4,000 at locations outside of the business premises) then carrier A. By virtue of determining a particular policy limit for particular product, carrier component 112 only generates product determination that are applicable to the user.

In some embodiments, different carriers may be determined by carrier component 112 for different coverage recommendations for a particular product. For example, different carriers may offer different products with different coverage limits and different premiums. For example, carrier A may offer a Business Owners Policy (BOP) at an annual premium of $1,000 but does not offer a Professional Liability (PL) policy. Alternatively, carrier B offers both a BOP and a PL, however, the BOP policy is offered at an annual premium of $1,500. Circumstances may exist that would make it more cost effective to purchase the BOP form carrier A (at a lower premium) and the PL policy from carrier B. In other circumstances, it may be more cost effective to purchase both the more expensive BOP along with the PL policy from Carrier B. For example, carrier B may offer a discount if both products are purchased altogether (i.e., bundled). In other cases it may be more convenient to purchase both the more expensive BOP along with the PL policy from Carrier B. For example, it may be easier for the customer to only pay one bill associated with carrier B. In some embodiments, carrier component 112 may be configured to determine if bundling of products would result in a more preferred option for the user by utilizing the one or more personal preferences determined by business information component 106, as alluded to above.

In some embodiments, different carriers may be determined based on carrier performance factors. For example, carrier performance factors may include carrier's claim handling rate, reputation, financial stability, or third-party ratings may be used by carrier component 112. In some embodiments, carrier component 112 may be configured to assign specificity, relevance, confidence, and/or weight to different products and different coverage limits offered by each carrier as well as each carrier performance factor, described above, during carrier determination.

In some embodiments, recommendation component 114 may be configured to generate one or more recommendations based on product and coverage limits determined by coverage component 110. For example, individual coverage recommendations may be generated based on one or more relevant products and coverage limits determinations made by coverage component 110 may be configured.

In some embodiments, the recommendations may include one or more reasons associated with a coverage recommendation. For example, a coverage recommendation reason may include an explanation a particular insurance product is applicable to user's business circumstances. For example, a reason a business owner needs a Business Owners Policy (BOP) is because it covers property damage including, real property and equipment or vehicles. For example, based on the business information, indicating that the user is an accountant working in a rented building, the recommendation may state: “You need a BOP in case someone slips and falls on your property.” Alternatively, if the business information indicates that user is an accountant that works with clients remotely from his home but also visits their client's sites, the recommendation may state: “You need a BOP to cover your loss if your presence at the client's home or office causes damage or injury.” In some instances, in addition to property damage, BOP may also cover reputational damage (e.g., defamation). In that scenario, even if the business information indicates that user is an accountant that works with clients remotely from his home, the recommendation may state: a client is sued for a marketing campaign you suggested.”

In some embodiments, recommendation component 114 may be configured to generate a default coverage recommendation reason. For example, a default coverage recommendation reason can include a statement: “You need General Liability coverage because your business could accidentally harm somebody or their property.” In some embodiments, recommendation component 114 may be configured to generate an industry specific coverage recommendation reason. For example, an industry specific coverage recommendation reason generated for a Hair Salon business can include a statement: “You need General Liability coverage because someone could be hurt in your salon.”

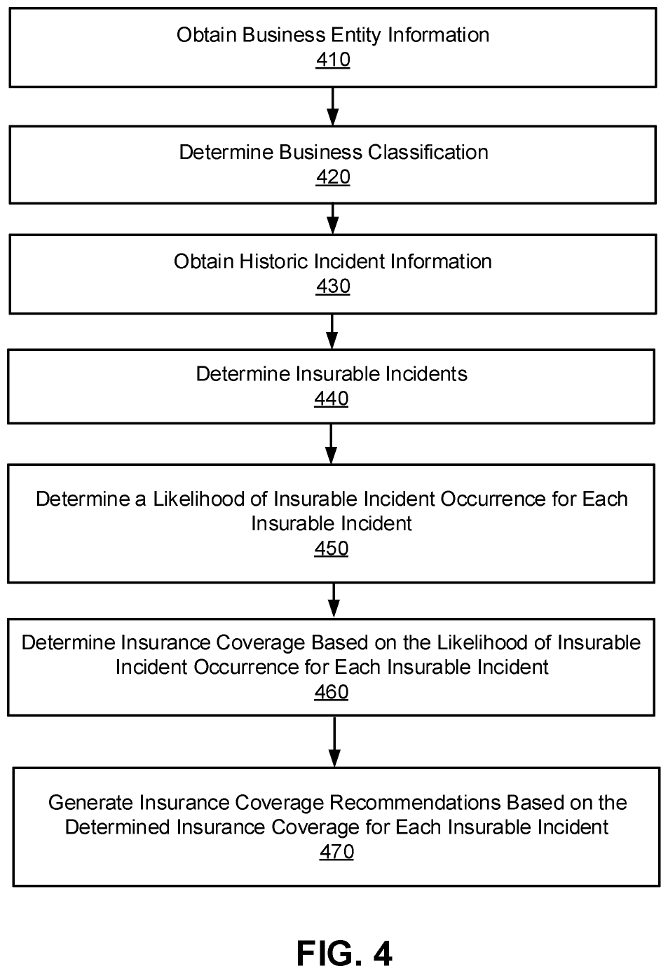

FIG. 4 illustrates a flow diagram describing a method for generating an insurance coverage recommendation based on the business information provided by a user, in accordance with one embodiment. In some embodiments, method 400 can be implemented, for example, on a server system, e.g., coverage recommendation server 120, as illustrated in FIGS. 1-2.

At operation 410, coverage recommendation engine 126 obtains business information related to a user's business entity. For example, the information related to the industry of their operation, property owned by the business, and number of employees, and other relevant data. At operation 420, business information component 106 determines business classification based on business information in step 410. For example, business information component 106 may determine that a business is in a Hair Salon.

At operation 430, coverage recommendation engine 126 obtains historic claim information related to other users of coverage recommendation system 100 based on the business classification determined in step 420. At operations 440 and 450, insurable incident component 108 determines insurable incidents associated with the user and a likelihood of each insurable incident occurrence based on the business information in step 410 and historic incident information in step 430, respectively.

At operation 460, coverage component 110 determines insurance products and assorted coverage limits that are relevant to user's based on business classification in step 420, and insurable incidents and a likelihood of each insurable incident in steps 440, 450, respectively. At operation 470, recommendation component 114 generates one or more coverage recommendations based on product and coverage limits determined in step 460.

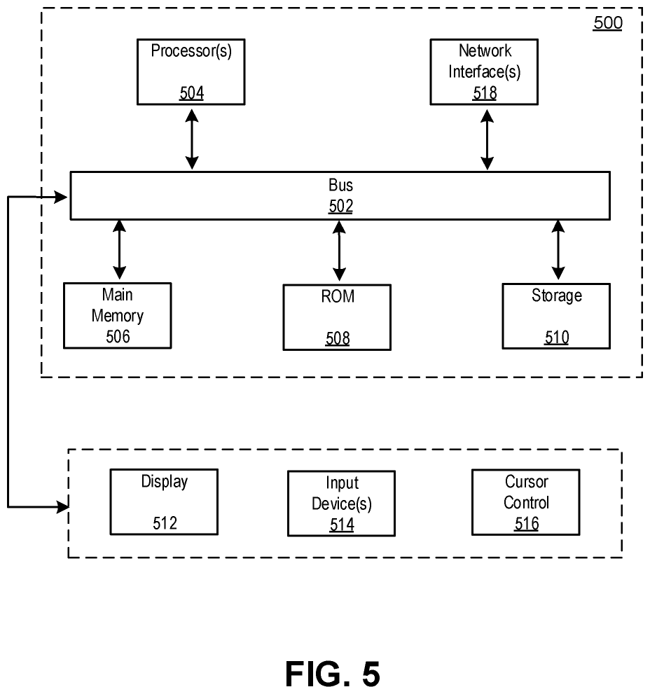

FIG. 5 depicts a block diagram of an example computer system 500 in which various of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 505, such as a random access memory (RAM), cache and/or other dynamic storage devices, coupled to bus 502 for storing information and instructions to be executed by processor 504. Main memory 505 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

In general, the word “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, Javascript, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression, or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 505. Such instructions may be read into main memory 505 from another storage medium, such as storage device 510. Execution of the sequences of instructions contained in main memory 505 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 505. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

1. A method for generating a coverage recommendation, the method comprising:
obtaining, by a coverage recommendation engine, business information for a business entity;
determining, by the coverage recommendation engine, a business type of the business entity based on the business entity information;
obtaining, by the coverage recommendation engine, historic incident information for business entities of the business type, wherein the historic incident information comprises historic incidents that adversely affected the business entities;
determining, by the coverage recommendation engine, a likelihood of occurrence of one or more incidents that adversely impact the business entity based upon the business information and the historic incident information;
determining, by the coverage recommendation engine, a coverage product for mitigating the likelihood of occurrence of each incident;
generating, by the coverage recommendation engine, a coverage recommendation including an explanation for the coverage product determination; and
effectuating, by the coverage recommendation engine, presentation of the coverage recommendation to the user via a graphical user interface;
wherein the explanation comprises one or more statements specifying one more reasons why the coverage product is recommended.

2. The method of claim 1, wherein the business information comprises information related to the business entity including at least one of a services performed by the business entity, employees employed by the business entity, real property occupied by the business entity during performance of the services, a geographic location of the real property, one or more geographic locations in which the business services are performed by the business entity, assets owned by the business entity, vehicles used by the business entity during the performance of the services, and revenue; and
wherein the business information is provided by the user via the graphical user interface.

3. The method of claim 2, further comprises obtaining one or more satellite images of the geographic locations associated with the real property occupied by the business entity.

4. The method of claim 3, wherein the determining the likelihood of occurrence of the one or more incidents is based on the satellite images of the geographic locations associated with the real property occupied by the business entity.

5. The method of claim 2, further comprising obtaining historic crime information related the geographic location of the real property occupied by the business entity during performance of the services and the one or more geographic locations in which the business services are performed by the business entity.

6. The method of claim 1, further comprising determining a coverage carrier providing the coverage product based on the coverage product determination.

7. The method of claim 2, further comprising obtaining regulatory requirements based on the information of employees employed by the business entity.

8. The method of claim 7, wherein the determining the coverage product utilizes the regulatory requirement.

9. The method of claim 1, further comprising receiving a selection from a user comprising the coverage product.

10. The method of claim 1, wherein the determining the likelihood of occurrence of the one or more incidents that adversely impact the business entity is calculated using Bayesian statistics.

11. A system for generating a coverage recommendation, the system comprising:
one or more physical processors configured by machine-readable instructions to:
obtain business information for a business entity;
determine business type of the business entity based on the business entity information;
obtain historic incident information for business entities of the business type, wherein the historic incident information comprises historic incidents that adversely affected the business entities;
determine a likelihood of occurrence of one or more incidents that adversely impact the business entity based upon the business information and the historic incident information;
determine a coverage product for mitigating the likelihood of occurrence of each incident;
generate a coverage recommendation including an explanation for the coverage product determination; and
effectuate presentation of the coverage recommendation to the user via a graphical user interface;
wherein the explanation comprises one or more statements specifying one more reasons why the coverage product is recommended.

12. The system of claim 11, wherein the business information comprises information related to the business entity including at least one of a services performed by the business entity, employees employed by the business entity, real property occupied by the business entity during performance of the services, a geographic location of the real property, one or more geographic locations in which the business services are performed by the business entity, assets owned by the business entity, vehicles used by the business entity during the performance of the services, and revenue; and
wherein the business information is provided by the user via the graphical user interface.

13. The system of claim 12, further comprises obtaining one or more satellite images of the geographic locations associated with the real property occupied by the business entity.

14. The system of claim 13, wherein the determining the likelihood of occurrence of the one or more incidents is based on the satellite images of the geographic locations associated with the real property occupied by the business entity.

15. The system of claim 12, further comprising obtaining historic crime information related the geographic location of the real property real property occupied by the business entity during performance of the services and the one or more geographic locations in which the business services are performed by the business entity.

16. The system of claim 11, further comprising determining a coverage carrier providing the coverage product based on the coverage product determination.

17. The system of claim 12, further comprising obtaining regulatory requirements based on the information of the employees employed by the business entity.

18. The system of claim 17, wherein the determining the coverage product utilizes the regulatory requirement.

19. The system of claim 11, further comprising receiving a selection from a user comprising the coverage product.

20. The system of claim 11, wherein the determining the likelihood of occurrence of the one or more incidents that adversely impact the business entity is calculated using at least one of a machine learning algorithms, neural networks, and deep learning algorithms.

21. A method being implemented by a computing system including one or more physical processors and storage media storing machine-readable instructions, the method comprising:
obtaining business information for a business entity;
determining business type of the business entity based on the business entity information;
determining a likelihood of occurrence of one or more incidents that adversely impact the business entity based upon the business information;
determining a coverage product for mitigating the likelihood of occurrence of each incident;
generating a coverage recommendation including an explanation for the coverage product determination; and
effectuating presentation of the coverage recommendation to the user via a graphical user interface;
wherein the explanation comprises one or more statements specifying one more reasons why the coverage product is recommended.
